(19) United States
(12) Patent Application Publication
(10) Pub. No.: US 2009/0148160 A1
(43) Pub. Date: Jun. 11, 2009

(54) Optical diplexer module using mixed-signal multiplexer

(75) Inventors: Kwon-Seob Lim, Gwangjoo-city (KR); Hyun Seo Kang, Gwangjoo-city (KR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Electronics and Telecommunications Research Institute

(21) Appl. No.: 12/154,455

(22) Filed: May 23, 2008

(30) Foreign Application Priority Data
Dec. 5, 2007 (KR) 10-2007-0125763

(51) Int. Cl. H04B 10/00; H04J 14/00

(52) U.S. Cl. 398/43; 398/115

(57) ABSTRACT

An optical diplexer module includes: an optical diplexer module comprising: a multiplexing unit multiplexing RF signals and a wideband digital signal having a baseband bandwidth to output a single multiplexed signal; an E-O converter converting the multiplexed signal into an optical signal and externally outputting the optical signal; and an O-E converter converting an externally received optical signal into an electric signal and outputting the electric signal. Similarly to existing optical transceivers, the optical diplexer module can provide TPS and MPS services using only two optical wavelengths for upstream and downstream signals. Since no separate optical wavelength is additionally required, the optical diplexer module can allows the numbers of components and processes to be reduced. It may result in yield improvement and cost reduction. Also, since electric or optical crosstalk between modules can be reduced, its performance can be improved.

### CROSS-REFERENCE TO RELATED PATENT APPLICATION

This application claims the benefit of Korean Patent Application No. 10-2007-0125763, filed on Dec. 5, 2007, in the Korean Intellectual Property Office, the disclosure of which is incorporated herein in its entirety by reference.

### BACKGROUND OF THE INVENTION

1. Field of the Invention

The present invention relates to an optical diplexer module and its application technology capable of providing various services including digital data communication such as Internet, analog video such as a cable television (CATV), the wireless Internet such as WLAN/Wibro, and mobile communication services such as code division multiple access (CDMA), wideband-CDMA (WCDMA), and global service for mobile telecommunication (GSM).

The present invention is derived from a research project supported by the Information Technology (IT) Research & Development (R&D) program of the Ministry of Information and Communication (MIC) and the Institute for Information Technology Advancement (IITA) [A Study on Development Technology of Optical Communications Components].

2. Description of the Related Art

Due to enormous jump-up of a data traffic amount in the Internet and steady increase in transmission capacities of data communication, needs on high-speed data transmission systems such as the gigabit Ethernet are continuously increasing. Studies on optical triplexer modules for, so called, a triple-play service (TPS) in which voice, data, and video services are provided using a conventional wavelength division multiplexing (WDM) technology via a single optical fiber are being progressed. In addition, quadruple-play service (QPS) businesses through mobile communication packaged resale start to be provided in the art.

However, the QPS packaged with mobile communication is not differentiated from the TPS except for lower prices obtained by a packaged service. In this point of view, the present invention proposes a multiple-play service (MPS) system and its application which allow the TPS and various services such as the wireless Internet, mobile communication, and IPTV to be integrated in a single system.

Conventional optical diplexer transceiver modules for digital bidirectional data communication use two optical wavelengths for bidirectional data communication, i.e., one for an upstream signal processing and the other for a downstream signal processing. However, conventional technologies for processing both of the video signals such as CATV and the data communication are required to have an optical triplex module which uses a separate optical wavelength for processing the video signals. In other words, if another service is added, an additional wavelength should be dedicatedly provided for that service. Furthermore, the system may become more complicated if the bidirectional service should be provided.

FIG. 1 illustrates a concept of a typical optical triplexer.

Referring to FIG. 1, three wavelengths λ₁, λ₂, and λ₃ are used to provide bidirectional data communication and video overlay service. In other words, the wavelength λ₁ is used for downstream data communication, λ₂ is used for upstream data communication, and λ₃ is used for a downstream video overlay service.

As shown in FIG. 1, since conventional optical triplexer modules additionally use a separate optical wavelength for processing the video signals, additional components such as an electrical-to-optical (E-O) converter or optical-to-electrical (O-E) converter, a WDM coupler, an amplifier, a driving circuit, and passive elements are required. Furthermore, mounting and optical alignment processes for these components are also added, and the number or processes increases, resulting in a reduced yield and a higher probability of errors in final products. The increased number of components also induces more frequent electric and optical crosstalk, and deteriorates performance of the module.

### SUMMARY OF THE INVENTION

The present invention provides an optical diplexer module and its application technology for a multiple-play service (MPS) capable of providing various services including digital data communication such as the Internet, analog videos such as CATV, the wireless Internet such as WLAN/WiBro, and mobile communication such as CDMA/WCDMA/GSM in a single system using only two optical wavelengths.

According to an aspect of the present invention, there is provided an optical diplexer module comprising: a multiplexing unit multiplexing RF signals and a wideband digital signal having a baseband bandwidth to output a single multiplexed signal; an E-O converter converting the multiplexed signal into an optical signal and outputting the optical signal; and an O-E converter converting a received optical signal into an electric signal and outputting the electrical signal.

According to another aspect of the present invention, there is provided an optical diplexer module comprising: an E-O converter converting an electric signal into an optical signal; an O-E converter converting a received optical signal into an electric signal; and a de-multiplexing unit separating RF signals and a wideband digital signal having a baseband bandwidth respectively from the output signal of the O-E converter and outputting the RF signals and the wideband digital baseband signal.

According to another aspect of the present invention, there is provided an optical diplexer module comprising: a multiplexing unit multiplexing RF signals and a wideband digital signal having a baseband bandwidth and outputting a single multiplexed signal; an O-E converter converting a received optical signal into an electric signal; and a de-multiplexing unit separating the RF signals and the wideband digital signal having the baseband bandwidth respectively from the output signal of the O-E converter and outputting the RF signals and the wideband digital baseband signal.

According to the present invention, it is possible to implement an optical diplexer module capable of providing TPS and MPS services using only two optical wavelengths for upstream and downstream signals similarly to conventional optical transceivers. Since no separate optical wavelength is additionally required, it is possible to reduce the numbers of components and processes in comparison with conventional optical triplexer modules for the TPS. It may lead to yield improvement and cost reduction. Also, it is also possible to reduce electric and optical crosstalk between components of the module and improve its performance. Furthermore, it is possible to simply implement an optical diplexer module for the TPS and MPS by using existing commercial products such as a transmitter optical subassembly (TOSA), a receiver optical subassembly (ROSA), and a bidirectional optical subassembly (BOSA).

Particularly, since various services can be provided using only two optical wavelengths, it is possible to omit additional complicated processes such an optical alignment, which is one of the very difficult packaging processes.

In addition, since the baseband/RF mixed-signal multiplexer proposed in the present invention functions as a low-pass filter as well as a band-pass filter inherently, no separate filter is additionally required. Therefore, it is possible to implement an optical diplexer module with lower cost. Also, the n×1 mixed-signal multiplexer allows users to selectively subscribe or withdraw desired one of n multiple services. That is, it is possible to provide various services such as the Internet, the wireless Internet, CATV, and mobile communication without modifying hardware just by simple connection in a plug-and-play (PnP) manner.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates an example of a conventional optical triplexer for a TPS service;

FIG. 2 illustrates an optical diplexer module using a mixed-signal multiplexing method according to an embodiment of the present invention;

FIG. 3 illustrates an optical diplexer module using a mixed-signal demultiplexing method according to an embodiment of the present invention;

FIG. 4 illustrates an example of a TPS service using an optical diplexer module according to an embodiment of the present invention;

FIG. 5 illustrates another embodiment of the present invention using two optical fibers;

FIG. 6 illustrates an example of a QPS service using an optical diplexer module according to an embodiment of the present invention;

FIG. 7 illustrates an example of an MPS service using an optical diplexer module according to an embodiment of the present invention;

FIG. 8 illustrates an example of an MPS service using an optical diplexer module in a WDM-PON system according to an embodiment of the present invention;

FIG. 9 illustrates an ideal frequency characteristic of a mixed-signal multiplexer proposed in the present invention;

FIG. 10A illustrates a scattering parameter characteristic which is a frequency characteristic of a 2×1 mixed-signal multiplexer proposed in the present invention. The multiplexer proposed in the present invention may be also used as a de-multiplexer;

FIG. 10B illustrates a scattering parameter characteristic which is a frequency characteristic of a 3×1 mixed-signal multiplexer proposed in the present invention. The multiplexer proposed in the present invention may be also used as a de-multiplexer;

FIG. 10C illustrates an output spectrum of multiplexer in transmitter part and an output spectrums of pre-amplifier and demultiplexer in receiver part of an optical diplexer module proposed in the present invention; and

FIG. 10D illustrates an eye diagram of multiplexed signals at pre-amplifier output and that of digital baseband signal at demultiplexer baseband port of an optical diplexer module proposed in the present invention.

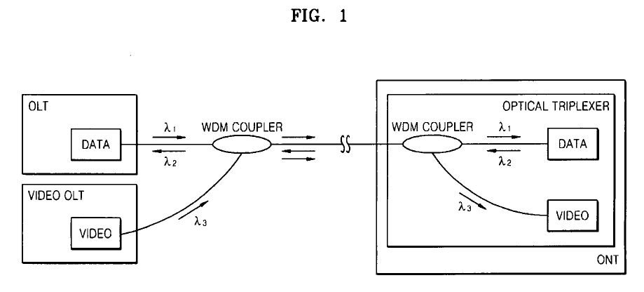

### DETAILED DESCRIPTION OF THE INVENTION

The present invention will now be described in detail with reference to the accompanying drawings.

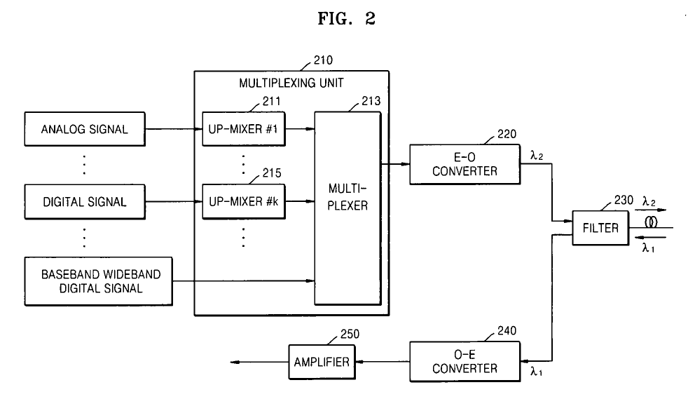

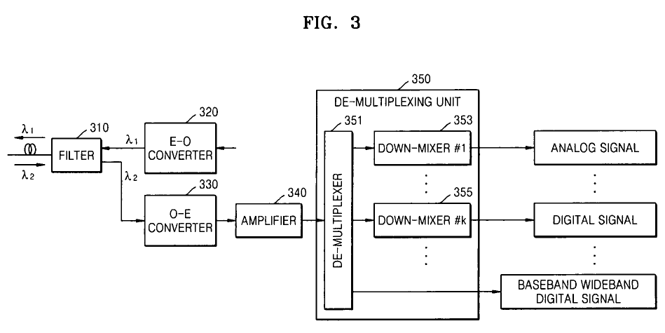

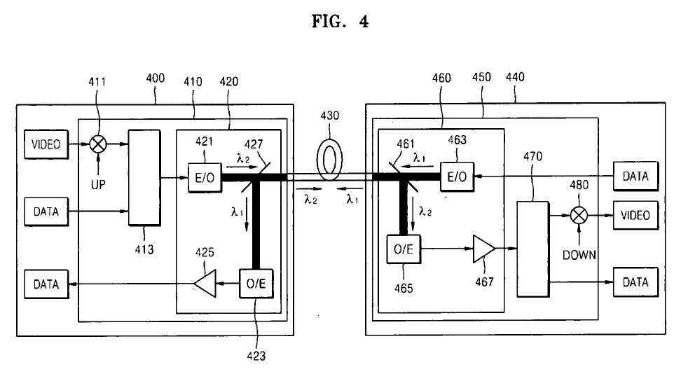

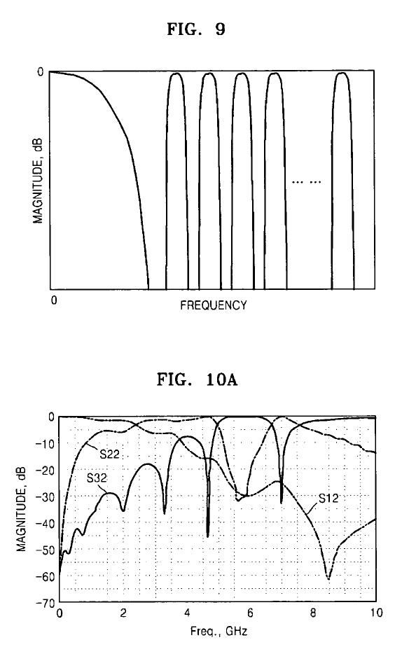

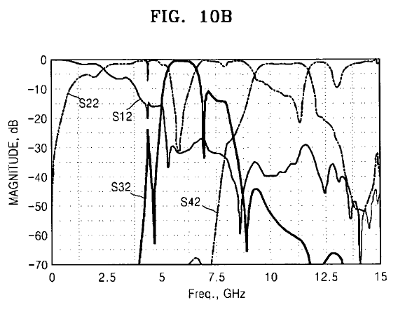

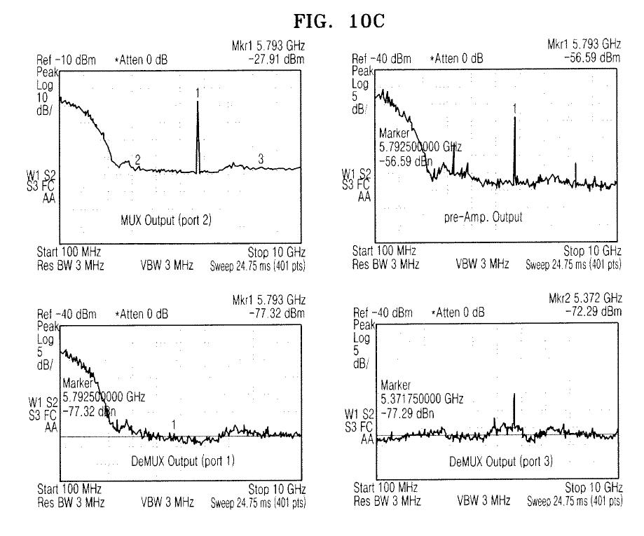

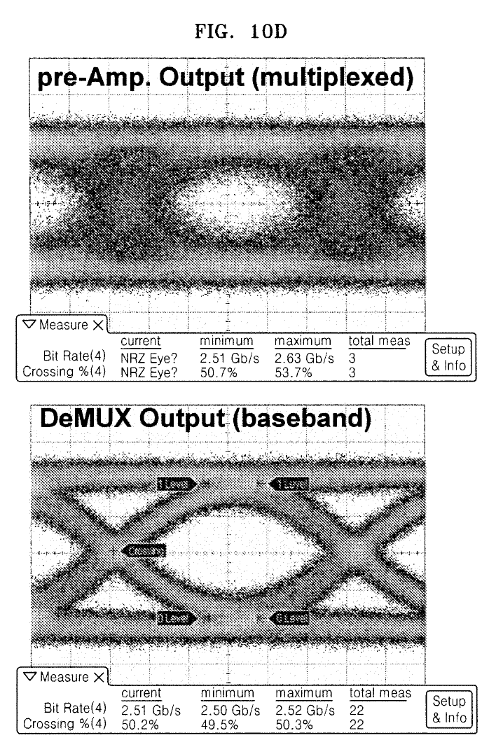

FIGS. 2 and 3 schematically show two configurations of optical diplexer modules using a mixed-signal (de)multiplexing according to the present invention. FIGS. 4 to 8 illustrate embodiments of the present invention. FIGS. 9 and 10A to 10D illustrate ideal frequency characteristics of a mixed-signal multiplexer, scattering parameter characteristics of a designed mixed-signal multiplexer, an output spectrums of an optical diplexer module, and, eye-diagrams for signals of an optical diplexer module respectively.

The optical diplexer module using a mixed-signal according to the present invention will be generally described with reference to FIGS. 2 and 3, and then, its applications will be described in more detail with reference to FIGS. 4 to 8. For simplicity of description and easy understanding, apparatuses and methods according to the present invention will be described together. In addition, like reference numerals denote like elements throughout FIGS. 2 and 3.

Preferably, the optical diplexer module using a mixed-signal multiplexing shown in FIG. 2 is applied to an optical line terminal (OLT). A multiplexing unit 210 multiplexes a wideband digital signal having a baseband bandwidth and at least one RF signal to output a single multiplexed signal. For this purpose, the multiplexing unit 210 may include at least one of up-mixers 211 and 215. It should be noted that the up-mixers 211 and 215 may include a first up-mixer 211 for converting one RF signal into a predetermined high frequency band and a second up-mixer 215 for converting another RF signal into a predetermined high frequency band. It should be noted that each up-mixer multiplies each input RF signal by an appropriate signal to convert into the high frequency band signal. Also, as will be described below, the mixers can be selectively applied only if needed.

The multiplexer 213 multiplexes output signals from each mixer or baseband signals not subjected to the mixer to output a multiplexed signal. The E-O converter 220 converts the multiplexed signal output from the multiplexer 213 into an optical signal to externally output the optical signal to, e.g., an optical network unit (ONU) or an optical network terminal (ONT). The O-E converter 240 converts the optical signal externally received from, e.g., an OLT into an electric signal. An amplification unit 250 has a function of amplifying an output signal from an O-E converter 240.

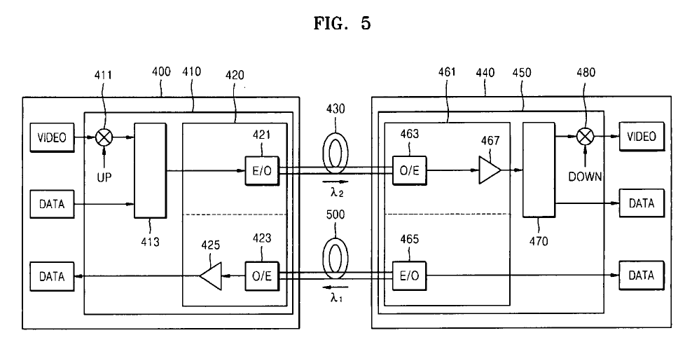

On the other hand, the filter 230 routes the externally received optical signals, and outputs the optical signals to the O-E converter 240, but it may be omitted in the embodiment shown in FIG. 5.

The filter 230 which is WDM filter may be implemented in a variety of types and how to implement the mixer or the amplifier will not be described in detail as it will be apparent to those skilled in the art.

Subsequently, referring to FIG. 3, there is shown another embodiment of the present invention, which is preferably applied to an ONU or an ONT. Firstly, the E-O converter 320 converts an electric signal into an optical signal. The filter 310 has functions of routing the optical signal externally input from, e.g., an OLT to route optical signals to the O-E converter 330, and externally transmitting the output optical signal of the E-O converter 320 to an OLT.

The O-E converter 330 converts the received multiplexed optical signal into an electric signal, and the de-multiplexer 351 of the de-multiplexing unit 350 separates the wideband digital signal having the baseband bandwidth and at least one RF signal from the converted electric signal and outputs the wideband digital signal and the RF signals respectively. For this purpose, the de-multiplexing unit 350 may include at least one of down-mixers 353 and 355. Then, as will be apparent from an example described below, the mixers can be selectively applied only if needed.

Hereinafter, configurations of FIGS. 2 and 3 will be described in more detail with reference to FIGS. 4 to 8.

FIG. 4 illustrates a concept of bidirectional data communication and video services using an optical diplexer via a single optical fiber link according to an embodiment of the present invention. The optical diplexer module can provide the same services using only two wavelengths as the conventional optical triplexer module, which uses three wavelengths.

Referring to FIG. 4, the optical diplexer module 410 for an OLT 400 may comprise: a mixer 411 for converting a frequency band of a video signal into a high frequency band to isolate the RF video signal from the wideband optical digital signal having the baseband bandwidth; a 2×1 baseband/RF mixed-signal multiplexer 413 for multiplexing the downstream wideband digital data signal and the RF video signal; an E-O converter 421 for converting the multiplexed electric signal into an optical signal; an O-E converter 423 for converting an upstream optical signal into an electric signal; a WDM filter 427 for routing the upstream optical signal into the O-E converter 423; and an amplifier 425 for converting an electric current of the electric signal generated in the O-E converter 423 into a voltage and amplifying the voltage signal.

An optical diplexer module 450 for an optical network terminal (ONT) or a set-top box (STB) 440 proposed in the present invention may comprise: a WDM filter 461 for routing a downstream optical signal obtained by mixing a RF video signal and a digital data signal having a baseband bandwidth delivered from the OLT 400 into the O-E converter 465; an O-E converter 465 for converting the optical signal into an electric signal; an amplifier 467 for converting an electric current of the electric signal generated in the O-E converter 465 into a voltage and amplifying the voltage signal; a 2×1 mixed-signal de-multiplexer 470 for demultiplexing the amplified mixed-signal into the RF video signal and the wideband digital data signal having a baseband bandwidth; a mixer 480 for converting the RF video signal that has been converted into a high frequency band back to the original frequency band; and an E-O converter 463 for converting an upstream wideband digital data electric signal into an optical signal. The WDM filters 427 and 461 may be implemented in various types.

FIG. 5 illustrates a concept of bidirectional data communication and video service using two optical fiber links 430 and 500 according to another embodiment of the present invention. In FIGS. 4 and 5, like reference numerals denote like elements, and their operations and configurations are similar to each other. Therefore, their description will be omitted. Since two optical fiber links are used in the configuration shown in FIG. 5, the WDM filters 427 and 461 are not necessary.

Since only two wavelengths similar to those in the optical transceiver are used in the optical diplexer modules 410 and 450 proposed in the present invention, the optical diplexer modules 410 and 450 may be easily implemented with existing commercial products such as BOSA, ROSA or TOSA.

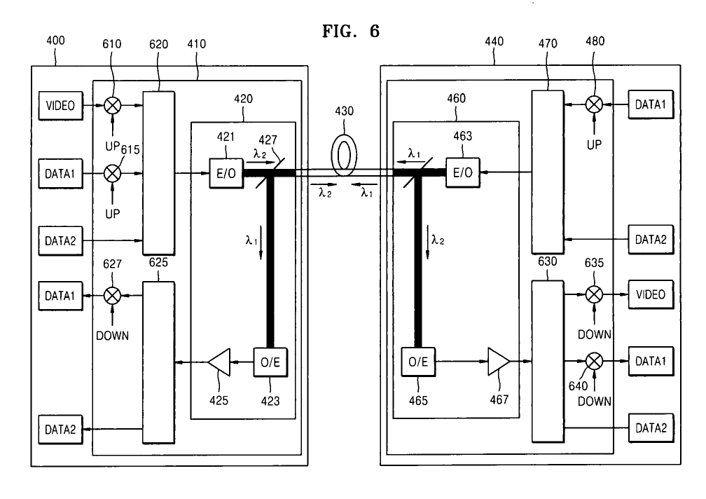

FIG. 6 illustrates a concept of a QPS service and a QPS service system obtained by adding a mobile communication or a wireless Internet service to the TPS service shown in FIG. 4 by using a 2×1 mixed-signal multiplexer/de-multiplexer 470/625 and a 3×1 mixed-signal multiplexer/de-multiplexer 620/630 via a single optical fiber link 430 according to another embodiment of the present invention. In FIGS. 4 and 6, like reference numerals denote like elements, and their operations and configurations are similar to each other. Therefore, their description will be omitted.

Similarly, mixers 480, 610, 615, 627, 635, and 640 can be selectively applied in this example.

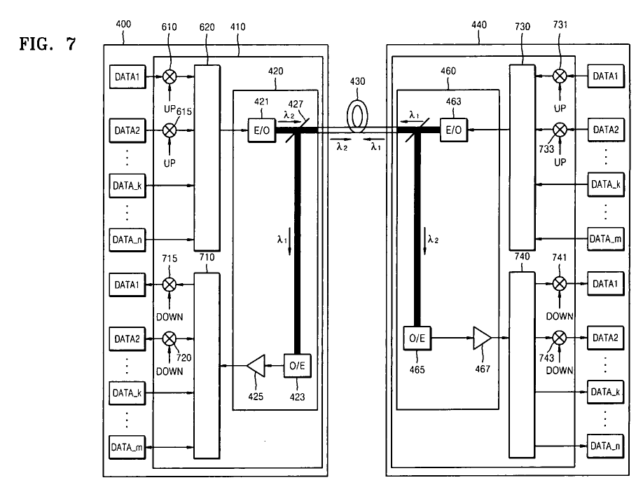

FIG. 7 illustrates a concept of a MPS service and MPS service systems 400 and 440 capable of providing n services using an n×1 mixed-signal multiplexer/de-multiplexer 620/740 and an m×1 mixed-signal multiplexer/de-multiplexer 730/710 according to another embodiment of the present invention. In FIGS. 4 to 6 and 7, like reference numerals denote like elements, and their operations and configurations are similar to one another. Therefore, their description will be omitted.

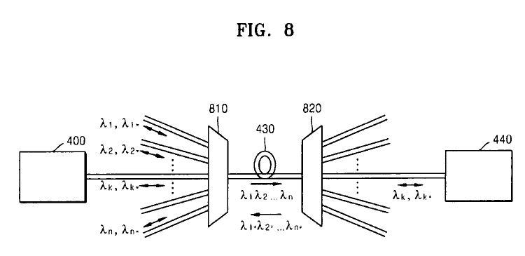

FIG. 8 illustrates a concept of an MPS service in a WDM-PON (WDM-passive optical network) system using an optical diplexer module proposed in the present invention according to another embodiment of the present invention.

Referring to FIG. 8, the WDM-PON system includes a plurality of OLTs 400 and WDM multiplexers 810, and each optical signal downwardly transmitted from corresponding OLTs 400 has a single particular wavelength. Optical signals having a plurality of different wavelengths are multiplexed by the WDM multiplexer 810, and transmitted via an optical fiber link 430. The transmitted optical signals having different wavelengths are demultiplexed and transmitted to corresponding ONTs or STBs 440 by the WDM de-multiplexer 820 located in a remote node. In addition, the digital upstream data signals from each ONT or STB 440 are transmitted using different optical wavelengths, multiplexed by the WDM de-multiplexer 820 located in a remote node, transmitted to a service provider via a single optical fiber 430, and distributed to corresponding OLTs 100 by the WDM multiplexer 810 of the WDM-PON system.

Hereinbefore, there have been described an optical diplexer module capable of providing an MPS service using baseband/RF mixed-signal multiplexer(s) and only two wavelengths for upstream and downstream transmission and a method thereof.

FIG. 9 illustrates an ideal frequency characteristic of an n×1 mixed-signal multiplexer, which is capable of multiplexing RF signals and a wideband digital signal having a baseband bandwidth, or demultiplexing the RF signals and the wideband digital baseband signal into original ones reversely.

FIG. 10A illustrates a scattering parameter, i.e., a frequency characteristic of a 2×1 mixed-signal multiplexer designed for the present invention. FIG. 10A shows a Bessel low-pass filter characteristic having a linear phase and a cut-off frequency of about 2.4 GHz, and a band-pass filter having a center frequency of about 5.8 GHz, a bandwidth of about 2 GHz, and insertion and return losses of about 0.2 dB and 31 dB, respectively, at the center frequency. In addition, it has good isolation characteristics of about 30 dB for RF port and 20 dB for the baseband port. Therefore, the 2×1 mixed-signal multiplexer was designed to multiplex and simultaneously transmit wideband digital and RF video signals by converting the RF video signal into 5 to 6 GHz band signal using a mixer. In addition, if the aforementioned mixed-signal multiplexer is applied to a wired and wireless system, it can directly multiplex a wideband digital signal such as a multi-gigabit Ethernet and an IEEE802.11a WLAN signal of 5.8 GHz without a mixer.

FIG. 10B illustrates a scattering parameter of a 3×1 mixed-signal multiplexer designed for the present invention. FIG. 10B shows a Bessel low-pass filter characteristic having a linear phase and a cut-off frequency of about 2.4 GHz and two band-pass filters having a center frequency of 5.8 GHz and 11.1 GHz, and insertion and return losses of 0.3 dB and 30 dB, and 1.2 dB and 20 dB, respectively, at the center frequency. In addition, it has good isolation characteristics of about 30 dB for two RF signals and has an excellent isolation property for the baseband signal as shown in FIG. 10B.

As described above, since the mixed-signal multiplexer proposed in the present invention functions as a low-pass filter as well as a band-pass filter inherently, and thus, no additional filter is required, an optical diplexer module can be provided with a lower price and a smaller size, and it can be also used as a de-multiplexer.

FIG. 10C shows the output spectrum of multiplexer in transmitter part at the RF input power of −20 dBm and the output spectrums of pre-amplifier and demultiplexer in receiver part at the average optical power of −20 dBm respectively. Once 2.5 Gb/s baseband signal and 5.8 GHz band IEEE802.11a WLAN signal are multiplexed by the multiplexer at the transmitter part, the multiplexed signals are converted to optical signals and transmitted on a single wavelength of 1550 nm over a 10-km-long distance single mode fiber. The multiplexed optical signals are converted to electrical signals by a photo detector, and then amplified by a pre-amplifier. The amplified multiplexed signals are demultiplexed by the demultiplexer and distributed to the target services. We obtained the clear eye diagrams of 2.5 Gb/s NRZ PRBS 2²³−1 signal at the baseband output port of demultiplexer at the optical power of −20 dBm when the RF input power in transmitter part was −20 dBm.

FIG. 10D shows measured eye diagram of multiplexed signals at pre-amplifier output and that of digital baseband signal at demultiplexer baseband port. As shown in FIG. 10D, the eye diagram of baseband output port of demultiplexer is much clearer than that of pre-amplifier output due to elimination of RF signal.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An optical diplexer module comprising:
a multiplexing unit multiplexing RF signals and a wideband digital signal having a baseband bandwidth to output a single multiplexed signal;
an E-O converter converting the multiplexed signal into an optical signal and outputting the optical signal; and
an O-E converter converting a received optical signal into an electric signal and outputting the electric signal.

2. The optical diplexer module according to claim 1, wherein the multiplexing unit comprises:
a first up-mixer converting the analog RF signal into a predetermined high frequency band; and
a multiplexer multiplexing the output signal of the first mixer and the wideband digital signal having the baseband bandwidth to output a multiplexed signal.

3. The optical diplexer module according to claim 2, wherein the multiplexing unit further comprises a second up-mixer which converts the digital RF signal into a predetermined high frequency band.

4. An optical diplexer module comprising:
an E-O converter converting an electric signal into an optical signal;
an O-E converter converting a received optical signal into an electric signal; and
a de-multiplexing unit demultiplexing RF signals and a wideband digital signal having a baseband bandwidth from the output signal of the O-E converter and outputting the each RF signal and the wideband digital signal.

5. The optical diplexer module according to claim 4, wherein the de-multiplexing unit comprises a down-mixer which converts high frequency band RF signals output from the O-E converter into the original frequency band RF signals.

6. The optical diplexer module according to claim 1, wherein the O-E converter further comprises an amplifier which converts the current signal to a voltage signal and amplifies the voltage signal.

7. The optical diplexer module according to claim 1, further comprising a filter routing the received optical signal to the O-E converter and outputting the optical signal from the E-O converter.

8. The optical diplexer module according to claim 4, wherein the O-E converter further comprises an amplifier which converts the current signal to a voltage signal and amplifies the voltage signal.

9. The optical diplexer module according to claim 4, further comprising a filter routing the received optical signal to the O-E converter and outputting the optical signal from the E-O converter.

10. An optical diplexer module comprising:
a multiplexing unit multiplexing RF signals and a wideband digital signal having a baseband bandwidth and outputting a single multiplexed signal;
an O-E converter converting a received optical signal into an electric signal; and
a de-multiplexing unit demultiplexing the RF signals and the wideband digital signal having the baseband bandwidth from the output signal of the O-E converter and outputting each RF signal and the wideband digital signal respectively.

11. The optical diplexer module according to claim 10, wherein the multiplexing unit comprises:
a first up-mixer converting one RF signal into a predetermined high frequency band;
a second up-mixer converting another RF signal into a predetermined high frequency band; and
a multiplexer multiplexing the output signals from the up-mixers and a wideband digital signal having a baseband bandwidth and outputting the multiplexed signal.
